(19) United States
(12) Patent Application Publication
(10) Pub. No.: US 2004/0189867 A1
(43) Pub. Date: Sep. 30, 2004

(54) Method and system for displaying a video frame

(76) Inventors: Anna Pelagotti, Eindhoven (NL); Maria Gabrani, Gattikon (CH); Gerard Anton Lunter, Eindhoven (NL)

Correspondence Address: Philips Electronics North America Corporation, Corporate Patent Counsel, PO Box 3001, Briarcliff Manor, NY, 10510, US

(21) Appl. No.: 10/479,558

(22) PCT Filed: Jun. 5, 2002
(86) PCT No.: PCT/IB02/02066

(30) Foreign Application Priority Data
Jun. 8, 2001 (DE) 01202209.1

(51) Int. Cl. H04N 5/14; H04N 11/20

(52) U.S. Cl. 348/459; 348/699

(57) ABSTRACT

Nowadays, continuous media data processing is performed more and more by programmable components, rather than dedicated single-function components. To handle such data appropriately, a system must guarantee sufficient system resources for processing. The method according to the invention proposes scalable motion compensated up-conversion of the frame rate of video sequences. By computing suitable quality measures for the algorithms (404) that perform the up-conversion (402), the method according to the invention allows to predict the required resources given an input video (406). Furthermore, the visual quality of the output video sequence is predicted. Based upon these predictions, the method selects the best algorithm to perform the up-conversion thereby allowing an optimal resource utilization of the system, for example a programmable platform for media processing.

The invention relates to a method of displaying a video frame, the method comprising

a first step of computing at least one predefined measure of a video signal;

a second step of using an algorithm to compute the video frame from the video signal.

Furthermore the invention relates to a system for displaying a video frame, the system comprising:

first computing means conceived to compute at least one predefined measure of a video signal;

second computing means conceived to compute the video frame from the video signal.

An embodiment of the method as set forth above is known from article Adaptive Global Concealment of Video up-conversion artefacts (Olukayode A. Ojo and Herman Schoemaker: IEEE Trans. on CE, Vol. 47, No. 1, February 2001, pp 40-46). Here, a method of suppressing image degradation due to motion compensation artifacts is disclosed. The method estimates global image degradation to determine the required level of error concealment. Motion compensation is performed because of video up-conversion from, for example 50 Hz to 100 Hz within consumer television. Similarly, 60 Hz interlaced pictures are converted to a progressive format to eliminate line flicker. There is also conversion of movie material at 24 pictures per second to different video standards for broadcast purposes and, within the multimedia domain, conversion of video images from various TV standards to different PC formats and vice versa is required. The method conceals errors by replacing intermediate interpolated pictures with original pictures depending upon the motion vector quality. The motion vector quality is derived from the input video signal. When the motion vector quality is low, i.e. a user perceives a low quality because of for example the presence of a halo, more original pictures replace the interpolated pictures. Halo's or ghost images occur when motion compensation is applied to an object moving across a detailed background. Because the estimated motion field extends beyond the boundaries of the moving object, the background is compensated with the wrong motion vector, leading to the halo or ghost image around the object. However, the pictures are displayed with the best quality possible depending upon the available resources. Then, those resources cannot be used by other applications that may run on the system.

It is an object of the current invention to provide a method that displays a video frame in an improved way. To achieve this object, the method of displaying a video frame is characterized in that the method further comprises:

a third step of providing a plurality of algorithms that are designed to compute the video frame from the video signal;

a fourth step of computing for at least one algorithm of the plurality of algorithms an output quality estimate based upon the at least one predefined measure of the video signal; and

a fifth step of selecting and performing a selected algorithm of the plurality of algorithms in order to display the video frame.

By computing an output quality for all the algorithms that are designed to compute a video frame from a video signal within the system, the algorithm that provides the best output quality can be chosen to be performed. However, this best output quality may not be the absolute best output quality that can be provided by the algorithms but it may also be an acceptable output quality perceived by a user. A user can perceive an acceptable output quality when the system provides a stable output quality of the displayed video frames. To this end, quality level changes should be initiated when the complexity of the video signal changes for a longer period, such as is the case at scene boundaries.

An embodiment of the method according to the invention is described in claim 2. By selecting the algorithm from the plurality of algorithms that provides the highest output quality, the displayed video frame can provide the highest quality possible based upon the input video signal.

An embodiment of the method according to the invention is described in claim 3. By selecting the algorithm from the plurality of algorithms that requires the lowest amount of resources, the resources can be used more optimal by the underlying system. Possible resource excess can then be reallocated to other applications that can run on the system.

An embodiment of the method according to the invention is described in claim 4. By choosing the algorithm that requires at most a predefined amount of resources while providing the best output quality, excessive resource consumption can be prevented during the display of the video frame with the highest possible quality.

An embodiment of the method according to the invention is described in claim 5. By choosing the algorithm that provides at least a predefined output quality, while requiring the lowest amount of resources, a acceptable quality of the displayed video frame can be provided while using a low amount of resources.

An embodiment of the method according to the invention is described in claim 6. By selecting an algorithm that requires at most a predefined amount of resources, the amount of resources used to compute the output video frame can be controlled by the system.

An embodiment of the method according to the invention is described in claim 7. By selecting an algorithm that provides at least a predefined output quality, excessive quality changes within the displayed video frames can be prevented.

An embodiment of the method according to the invention is described in claim 8. By basing the measures upon motion estimation within the video signal, state of the art motion estimation metrics can be used to predict the output quality for each algorithm.

An embodiment of the method according to the invention is described in claim 9. Within scan-rate up-conversion, the output quality of the intermediate frames can differ considerably depending upon the motion within the input video signal. By estimating the output quality of the different up-conversion algorithms, the best algorithm can be chosen that provides the most stable output quality for the current video frame sequence.

Furthermore, it is an object of the current invention to provide a system that displays a video frame in an improved way. To achieve this object, the system for displaying a video frame is characterized in that the method further comprises:

algorithm bank means (810) conceived to provide a plurality of algorithms that are designed to compute the video frame from the video signal;

third computing means (808) conceived to compute for at least one algorithm of the plurality of algorithms an output quality estimate based upon the at least one predefined measure of the video signal; and

selecting means (810) conceived to select and perform a selected algorithm of the plurality of algorithms in order to display the video frame.

The invention will be described by means of embodiments illustrated by the following drawings:

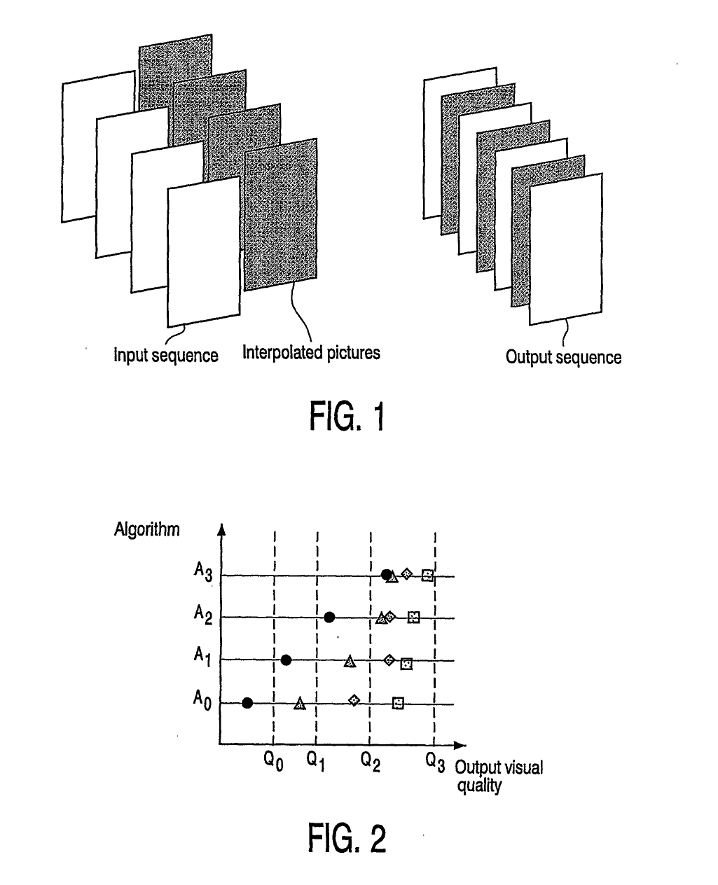

FIG. 1, illustrates scan-rate up-conversion of a video sequence;

FIG. 2 illustrates the visual output quality dependence of a number of conversion algorithms on the complexity of motion of the input sequence;

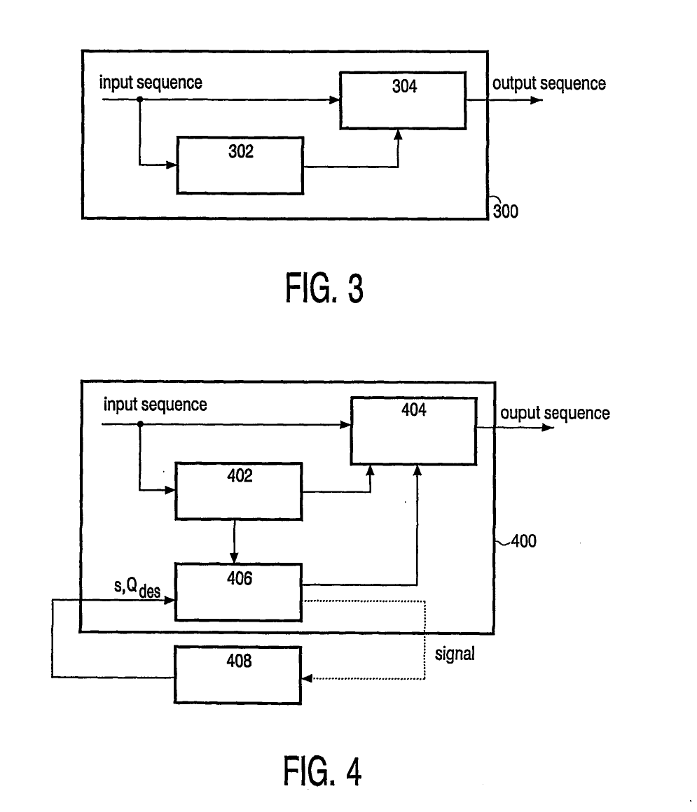

FIG. 3 illustrates a standard algorithm for scan rate up-conversion;

FIG. 4 illustrates the main parts of the scalable algorithm according to the invention;

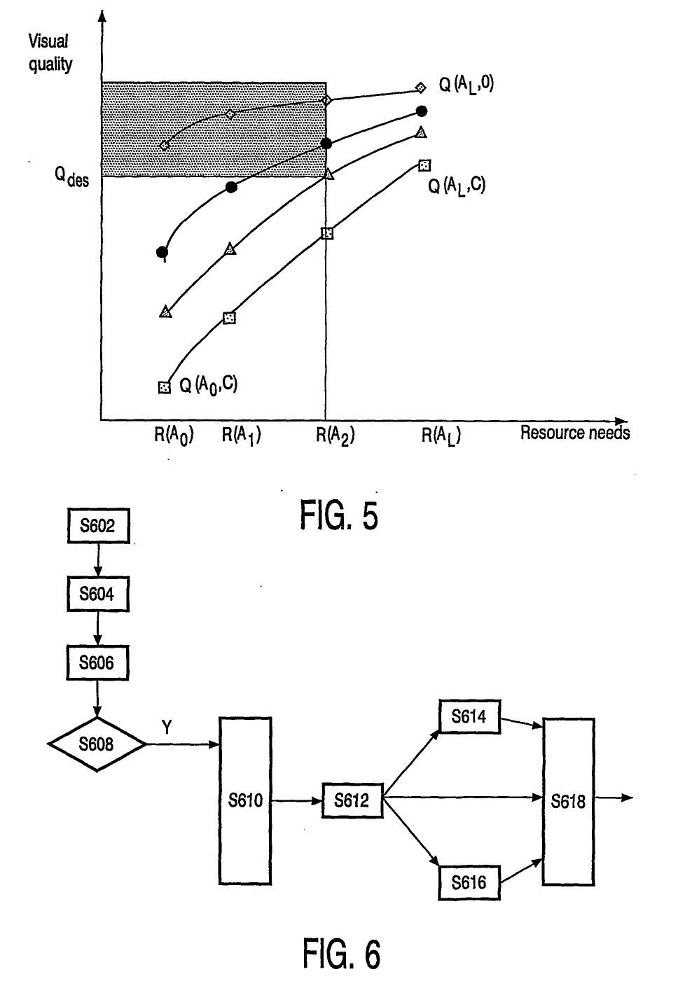

FIG. 5 illustrates the expected visual quality levels and resource needs for an algorithm from the algorithm bank dependent upon different input sequence complexity;

FIG. 6 illustrates the main steps of the method according to the invention;

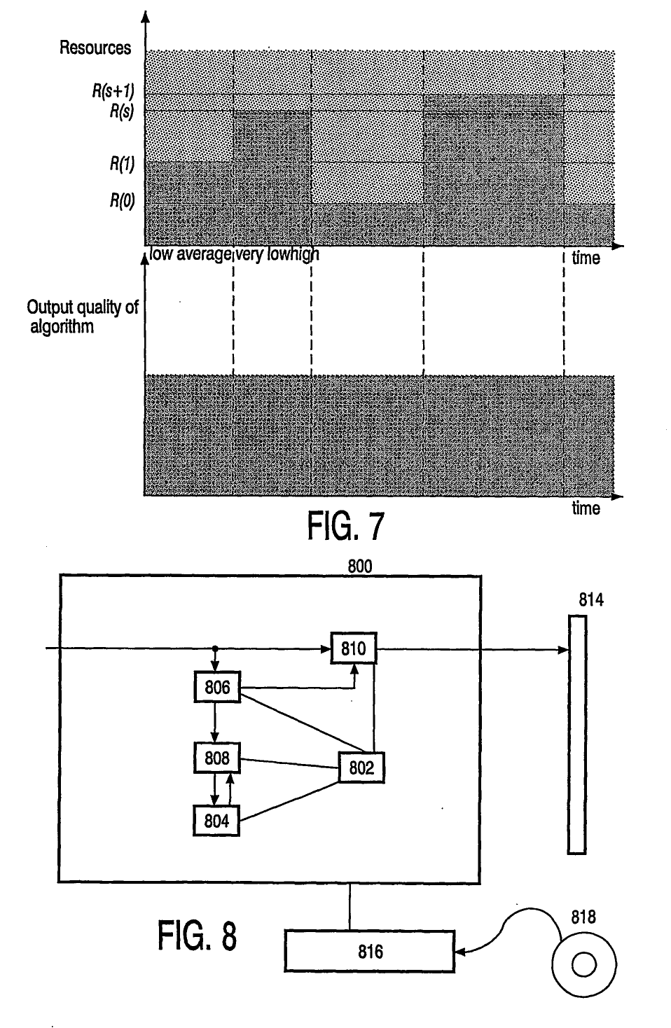

FIG. 7 illustrates input dependent processing;

FIG. 8 illustrates the most important part of an embodiment of the system according to the invention is a schematic way;

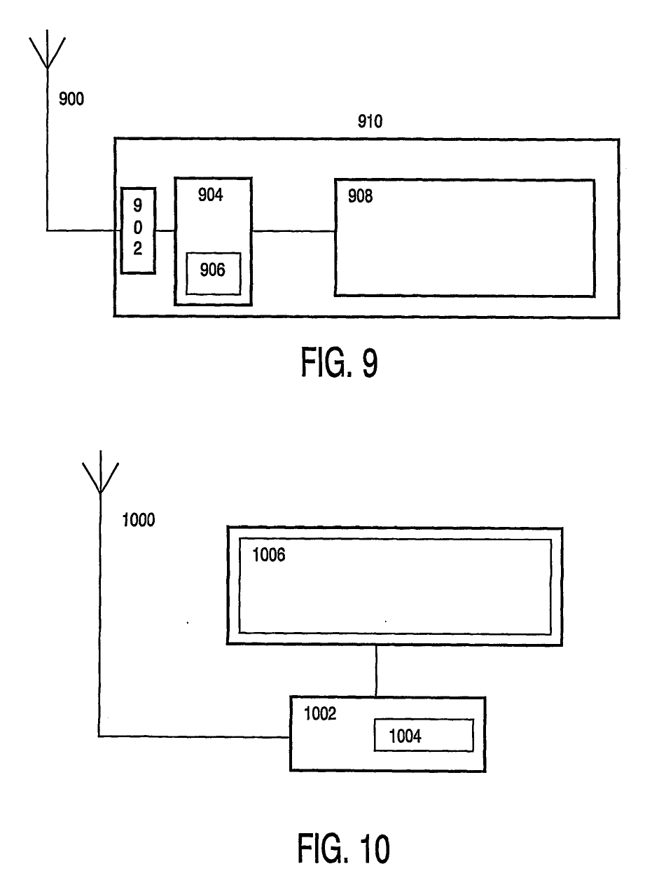

FIG. 9 illustrates a television set in a schematic way that comprises an embodiment of the system according to the invention;

FIG. 10 illustrates the most important parts of a set-top box in a schematic way that comprises an embodiment of the system according to the invention.

Nowadays, continuous media data processing is performed more and more by programmable components, rather than dedicated single-function components. To handle such data appropriately, a system must guarantee sufficient system resources for processing. Since real time resources, such as a CPU and memory, are finite, sufficient system resources may not be reserved for a particular processing session. This limits the number of processing sessions or other applications that can run on the system in parallel. One of these processing sessions, is the processing of an input video stream. Input video streams can be processed by a number of algorithms that are capable to provide different output quality of the output video stream. The quality of the output video stream depends also on the complexity of the input video stream. When the complexity of the input video stream varies, the output quality can vary too, which leads to a low perception by a user of the quality of the output video stream. Especially, when the video stream has the user focus. Therefore, a constant quality of the output video stream is desired. In order to achieve this, different input streams need to be processed by different algorithms that need different amount of resources. In order to provide the highest quality, all available resources can be assigned to the algorithm, but this reduces the number of applications that can be run in parallel on the system.

FIG. 1, illustrates scan-rate up-conversion of a video sequence, wherein intermediate pictures are calculated in between existing pictures in order to increase the picture rate from, for example, 50 Hz to 100 Hz. Several algorithms exist for scan rate up-conversion of a video sequence. They range from simple ones with low resource utilization, for example pixel shifting from only one original picture according to a motion vector, to more complex and expensive, for example, accessing more pixels in several original pictures in the sequence according to more than one motion vectors, and using non-linear filters. The difference in output quality of each of these algorithms varies considerably. Furthermore each individual algorithm can provide different output qualities that depend on the complexity of motion in the input sequence. In fact, the more complex methods have been designed specifically to cope with input sequences with complex motion.

FIG. 2 illustrates the visual output quality dependence of a number of conversion algorithms on the complexity of motion of the input sequence. If the input sequence exhibits only simple motion for example, no motion, or slow translation motion of rigid, non-transparent objects, then the algorithms will provide interpolated images of comparable quality, as illustrated by the squares within FIG. 2. Then, all algorithms, A₀ to A₃, provide an output quality between Q₂ and Q₃. In this case it is possible to significantly reduce resource utilization, while still achieving the required output quality. However, the circles within FIG. 2 illustrate that if in the input sequence there is complex motion with large occlusion areas, only complex algorithms can be used in order to have a certain quality. Then, for example algorithm A₃ provides an output quality between Q₂ and Q₃ while A₀ provides an output quality below Q₀. The diamonds within FIG. 2 illustrate the output quality of the algorithms for low complexity of the input stream and the triangles illustrate the output quality of the algorithms for average complexity of the input stream.

FIG. 3 illustrates a standard algorithm for scan rate up-conversion. The algorithm 300 consists of two parts: a motion estimation block 302 and a motion compensation block 304. The motion estimation block 302 computes motion vector fields from the original pictures, which are used by the motion compensation block 304 to compute intermediate pictures from.

FIG. 4 illustrates the scalable algorithm 400 according to the invention. This scalable algorithm 400 consists of three blocks. The motion estimation block 402 is the motion estimation block 302 from FIG. 3. An algorithm bank 404, consisting of several motion compensation algorithms that differ in output quality and resource usage replaces the motion compensation block 304. The third block comprises the control part 406 of the scalable algorithm 400. This control part 406 computes the output quality estimates for each of the algorithms in the algorithm bank, and makes sure that the resource requirement is met and the desired quality is reached when possible. The output quality estimates can be computed real-time, depending upon the input signal being received. The scalable algorithm 400 receives at least two new inputs from the underlying system 408: the maximum resource s that is available to the algorithm and the desired output quality Q_{des}. These two inputs s and Q_{des} are used by the control part 406 to decide upon which algorithm to choose to be executed. The responsibility of the scalable algorithm 400 as a whole is to stay below the resource limit, to produce output of at least the desired quality and use minimal resources when possible. Furthermore, the control part 406 can emit at least two signals to communicate with the underlying system 408. If the desired quality could be reached using less than the available resources it signals “resource excess”, it the desired quality could not be attained with all available resources, it signals “resource deficiency”.

FIG. 5 illustrates the expected visual quality levels and resource needs for an algorithm from the algorithm bank dependent upon different input sequence complexity. The graph connected with squares is applicable to an input sequence with very high complexity; the graph connected with triangles is applicable to an input sequence with high complexity; the graph connected with circles is applicable to an input sequence with medium complexity; and the graph connected with diamonds is applicable to an input sequence with low complexity. The algorithms comprised within the algorithm bank 404 see FIG. 4, are denoted by Aₗ, l=0, . . . , L. Their respective resource usage is denoted by R(Aₗ). The, estimated, output quality of algorithm Aₗ is expressed by a quality number Qₗ for which it holds that lower Q numbers correspond to lower visual quality. The quality numbers are computed in two steps. First, using the input video sequence and the motion vectors, some measures are computed that relate to the complexity of the scene, as appropriate for frame rate up-conversion. These measures are denoted by M₁, . . . , Mₖ. From these, the expected output quality Qₗ(M₁, . . . ,Mₖ) is computed, for each algorithm within the algorithm bank. The pairs (R(Aₗ),Qₗ), l=0, . . . , L, for fixed M₁, . . . , Mₖ, are called quality mappings see FIG. 5. Therefore, the quality mappings depend on the complexity of the scene, through the measures M₁, . . . ,Mₖ.

The performance of the scalable algorithm depends on how well the Q numbers describe the subjective perceptual performance of the respective algorithms. To this end users have been asked to score a number of input sequences that are processed with a number of up-conversion algorithms according to the invention.

Furthermore, the computation of the Q-functions can be cheap compared to executing the up-conversion algorithms, because the corresponding algorithm need not to be executed for its output quality to be estimated as described below.

In order to enable the method according to the invention to work faster, the algorithms are sorted by resource usage: R(A₀)<R(A₁)< . . . <R(A_{L}) and output quality: Q₀(M₁, . . . Mₖ)≦Q₁(M₁, . . . Mₖ)≦ . . . ≦Q_{L}(M₁, . . . , Mₖ) for all values of the measures M₁, . . . ,Mₖ. It is assumed that in general the resource usage of the algorithms does not depend on the video input. However the invention still applies when, in case of different input modes, i.e. film or video, the resource usage may depend on the video input. In case the resource usage depends on the image material, the numbers R(Aₗ) can be regarded as upper bounds to the actual resource requirements. These preferred sorting orders of resource usage and output quality can be violated, for example, cheap frame repetition may sometimes be better than expensive up-conversion using highly erroneous motion vectors. The algorithm presented below can be easily adapted to deal with this case, and this preferred sorting orders are not essential.

FIG. 6 illustrates the main steps of the method according to the invention. The first step S602 is an initialization step. Within this first step, the input parameters are provided to the method. The input parameters comprise the input video stream, the desired quality level Q_{des} and the resource level s, which denotes the most expensive up-conversion algorithm that can be used. Within the next step S604, motion vectors are computed from the input video stream. The computation of the motion vectors is based upon a state of the art block-based motion estimator that uses two pictures. This estimator uses a block metric to evaluate the quality of fit for a motion vector assigned to a block. More specifically, the motion estimation algorithm selects for each block of the picture the vector, from a small set of candidates, that yields the minimum error with respect to the block metric. A widely used metric is the Sum of Absolute Differences (SAD):

$$S A D ( n , n , h , v ) = \frac{1}{{N}_{1} {N}_{2}} {\sum }_{i = 1}^{{N}_{1}} {\sum }_{j = 1}^{{N}_{2}} \vert x ( i , j , n ) - x ( i + h , j + v , n + 1 ) \vert$$

In the above equation, x(i,j,n) is the luminance value of a frame at position (i,j) and time n, x(i+h,j+v,n+1) is the corresponding luminance value at time n+1 as indicated by the motion vector m=(h,v), and N₁ and N₂ are the height and width of the block respectively.

An other metric that can be used, and which is also very cheap to compute, is the Bad Block Burst (3B) metric of article Adaptive Global Concealment of Video up-conversion artefacts (Olukayode A. Ojo and Herman Schoemaker). The 3B metric counts the number of horizontally unbroken sequences of length L which have a SAD above some threshold K.

Using these motion vectors and the video input, error measures M₁, . . . , Mₖ are computed as previously described. Within step S606, quality estimates Q₀, . . . ,Q_{L} for all algorithms A₀, . . . ,A_{L} are determined by using a simple linear affine scale change. More accurate quality predictions may be obtained by using, for example, different metrics for each algorithm, or different combinations of metrics for each algorithm. The main point is that, during the vector selection one computes some metrics, and from their value predict the visual output quality for each up-conversion algorithm considered. These quality estimates depend highly upon the complexity of motion within the scene. Within step S608, each algorithm is considered, starting from the cheapest one, and it is determined whether it would yield at least the desired output quality Q_{des}. If it yields at least the desired output quality, step S610 is performed. Within step S610, the resource requirements of each algorithm that yields at least the desired output quality is compared. This step S610 produces a number l, with the meaning that Aₗ is the cheapest algorithm that produces output of the desired visual quality. The next step S612 compares the number l to the maximum resource level s. If l is equal to s, then the control block is done. If l is less than s, the control part emits the signal “resource excess” to the underlying system within step S614. In the remaining case l is larger than s, the signal “resource deficiency” is emitted, and l is reset to s within S616. Within the final step S618, the number l is sent to the algorithm bank, which executes the appropriate algorithm Aₗ.

To explain the algorithm graphically, note that all the quality mappings (Rₗ, Qₗ) in the shaded region of FIG. 6 satisfy the conditions R(Aₗ)≦R(Aₛ), which means that they stay below the available resources s and Qₗ≧Q_{des}, which means that they produce output of the desired quality Q_{des}. Under these conditions, the algorithm chooses an algorithm that minimizes resource usage. If no quality mappings exist in the shaded region, a mapping is selected within step S510, which gives best possible output given the resource consraint s.

FIG. 7 illustrates input dependent processing. It illustrates the resource demands for one algorithm over time. The lower part illustrates that the output quality remains the same, while the upper part illustrates that the resource usage changes over time depending upon the complexity of the input video stream: low, average, very low, and high. It should be noted that within a robust system, quality level changes and resource reallocations are not performed frequently. To this end, such changes should be initiated at points where the motion complexity changes for a longer period in for example the order of tens of pictures. Therefore, the quality and resource changes should be initiated at scene boundaries.

Furthermore, since the complexity of the scene can vary slowly in time, it is not necessary to compute the metrics every frame, which saves resources too.

The order in the described embodiment of the method of the current invention is not mandatory, a person skilled in the art may change the order of steps or perform steps concurrently using threading models, multi-processor systems or multiple processes without departing from the concept as intended by the current invention.

FIG. 8 illustrates the most important parts of an embodiment of the system according to the invention in a schematic way. The system 800 comprises a CPU 802. The system can also comprise more than one processor and co-processors. Furthermore, the system comprises the real-time system software within memory 804 that provides the maximum resource consumption and desired quality level and receives a possible resource excess or resource deficiency as previously described. Memory 806 comprises the software that calculates the motion vectors from the input stream and supplies these vectors to memory 808 that comprises the software to calculate quality predictions for each of the algorithms stored within the algorithm bank. Memory 810 provides access to the different algorithms that can calculate intermediate pictures for the frame-rate up-conversion. The system 800 is realized in software intended to be operated as an application run by a computer or any other standard architecture able to operate software. The system can be used to operate a digital television set 814. The software can also be updated from a storage device 818 that comprises a computer program product arranged to perform the method according to the invention. The storage device is read by a suitable reading device, for example a CD reader 816 that is connected to the system 800.

FIG. 9 illustrates a television set 910 in a schematic way that comprises an embodiment of the system according to the invention. Here an antenna, 900 receives a television signal. Any device able to receive or reproduce a television signal like, for example, a satellite dish, cable, storage device, internet, or Ethernet can also replace the antenna 900. A receiver, 902 receives the signal. The signal may be for example digital, analogue, RGB or YUV. Besides the receiver 902, the television set contains a programmable component, 904, for example a programmable integrated circuit. This programmable component contains a system according to the invention 906. A television screen 908 shows images that are received by the receiver 902 and are processed by the programmable component 904. When a user wants to record the received signal, for example a movie, the system according to the invention 906 records the received signal on the recording device like a DVD+RW, a compact disk or a harddisk. When a user wants to play a recorded movie, the system according to the invention 906 retrieves the appropriate data from the recording device.

FIG. 10 illustrates, in a schematic way, the most important parts of a set-top box that comprises an embodiment of the system according to the invention. Here, an antenna 1000 receives a television signal. The antenna may also be for example a satellite dish, cable, storage device, internet, Ethernet or any other device able to receive a television signal. A set-top box 1002, receives the signal. The signal may be for example digital, analogue, RGB or YUV. Besides the usual parts that are contained in a set-top box, but are not shown here, the set-top box contains a system according to the invention 1004. When a user wants to record the received signal, for example a movie, the system according to the invention 1004 records the received signal on the recording device like a DVD+RW, a compact disk or a harddisk. When a user wants to play a recorded movie, the system according to the invention 1004 retrieves the appropriate data from the recording device. The television set 1006 can show the output signal generated from a received signal by the set-top box 1002.

1. (original) A method of displaying a video frame, the method comprising:
a first step of computing at least one predefined measure of a video signal;
a second step of using an algorithm to compute the video frame from the video signal; characterized in that the method further comprises:
a third step of providing a plurality of algorithms that are designed to compute the video frame from the video signal;
a fourth step of computing for each of the plurality of algorithms a respective output quality estimate based upon the at least one predefined measure of the video signal; and
a fifth step of selecting and performing a selected algorithm of the plurality of algorithms in order to display the video frame.

2. (original) A method of displaying a video frame according to claim 1, wherein an output quality estimate of the selected algorithm is a highest output quality estimate among the respective output quality estimate.

3. (original) A method of displaying a video frame according to claim 1, wherein a resource requirement of the selected algorithm is a lowest resource requirement among a respective resource requirement of each of the plurality of algorithms.

4. (original) A method of displaying a video frame according to claim 2, wherein the selected algorithm requires at most a predefined amount of resources in order to provide the output quality estimate of the selected algorithm.

5. (original) A method of displaying a video frame according to claim 3, wherein the selected algorithm provides at least a predefined output quality estimate while requiring the resource requirement of the selected algorithm.

6. (original) A method of displaying a video frame according to claim 1, wherein the selected algorithm requires at most substantially equal to a predefined amount of resources.

7. (original) A method of displaying a video frame according to claim 1, wherein an output estimate of the selected algorithm is at least substantially equal to a predefined output quality.

8. (original) A method of displaying a video frame according to claim 1, wherein the predefined measure of the video signal is computed based upon output of a motion estimator, the motion estimator having the video signal as input.

9. (original) A method of displaying a video frame according to claim 1, wherein the algorithms perform scan-rate up-conversion.

10. (original) A system (800) for displaying a video frame, the system (800) comprising:
first computing means (806) conceived to compute at least one predefined measure of a video signal;
second computing means (808) conceived to compute the video frame from the video signal; characterized in that the method further comprises:
algorithm bank means (810) conceived to provide a plurality of algorithms that are designed to compute the video frame from the video signal;
third computing means (808) conceived to compute for at least one algorithm of the plurality of algorithms an output quality estimate based upon the at least one predefined measure of the video signal; and
selecting means (810) conceived to select and perform a selected algorithm of the plurality of algorithms in order to display the video frame.

11. (currently amended) A computer program product arranged to perform the method according to any of the claims 1 to 9claim 1.

12. (original) A storage device (818) comprising a computer program product according to claim 11.

13. (original) A television set (910) comprising a receiver (902) for receiving a video signal, a programmable component (904) for running a task processing the video signal, a display screen (908) for displaying the processed video signal and a system according to claim 10.

14. (original) A set-top box (1002) comprising a receiver (1002) for receiving a video and/or audio stream and decoding the video and/or audio stream, and a system according to claim 10.
